(19) United States
(12) Patent Application Publication
(10) Pub. No.: US 2014/0217036 A1
(43) Pub. Date: Aug. 7, 2014

(54) SYSTEMS AND METHODS FOR A NANOPARTICLE PHOTOCATALYZED THROUGH-FLOW DEGRADATION REACTOR

(71) Applicant: Christopher N. Bremer, Tempe, AZ (US)

(72) Inventor: Christopher N. Bremer, Tempe, AZ (US)

(73) Assignee: The Arizona Board of Regents for and on behalf of Arizona State University, Tempe, AZ (US)

(21) Appl. No.: 14/171,607

(22) Filed: Feb. 3, 2014

Related U.S. Application Data
(60) Provisional application No. 61/759,871, filed on Feb. 1, 2013.

(51) Int. Cl. C02F 1/72; C02F 1/14; B01D 5/00; B01J 19/12

(52) U.S. Cl. CPC C02F 1/725; B01J 19/123; C02F 1/14; B01D 5/006
USPC 210/748.14; 210/180

(57) ABSTRACT

A reactor system including a main reactor having a reaction vessel in operative communication with a solar concentrator for focusing sunlight onto the reaction vessel for providing waste management and removal is disclosed. The sunlight focused on the reactor vessel provides ultraviolet radiation that degrades organic pollutants within the reaction vessel and infrared radiation boils off the liquid within the reaction vessel, thereby allowing a steady state condition to be achieved in the reactor vessel. The main reactor is in communication with a condenser that receives the water vapor and other gases from the reactor vessel in which a phase separation operation occurs such that heavier water liquid phase is captured within a storage chamber and the gaseous phase is transported to a gas scrubber for filtering the lighter gaseous phase.

### CROSS REFERENCE TO RELATED APPLICATIONS

This is a non-provisional application that claims benefit to U.S. provisional application Ser. No. 61/759,871 filed on Feb. 1, 2013, and is herein incorporated by reference in its entirety.

### FIELD

The present disclosure generally relates to nanoparticle technologies and in particular to a nanoparticle photocatalyzed throughflow degradation reactor system.

### BACKGROUND

The nanotechnology field is growing at an increasingly rapid rate, much to the benefit of modern technology and science. As nanotechnology increases in complexity and usage, more emphasis is being placed on production, and not enough emphasis is being placed on sustainability. Just as we are faced with climate changes, increased pollution, and struggle for cheap fuel that are the fruits of the automotive revolution, we may very well be forced to face even more severe issues if we do not look to a sustainable nanotechnology future. Fortunately, nanoparticle properties are almost perfectly suited to sustainable applications.

Nanoparticles are very small, giving such particles a very large surface area to mass ratio (>150 m²/g), and some nanoparticles exhibit photoelectric properties when exposed to certain wavelengths of light. When combined these two distinct properties provide a very high photocatalytic activity. When certain nanoparticles are exposed to high-frequency photons, an electron may be “kicked” off of its surface from the valence band to the conducting band. Due to the surface-dependency of this property, the large surface area associated with nanoparticles is an integral part of their ability to be highly efficient photocatalysts. The removed electron can then be used to do work; in our specific application, we use this to break-down large organic dye pollutants such as Methylene Blue (abbreviated MB), Congo Red, and Acid Green.

Currently, textile industries worldwide use large industrial incinerators to incinerate these industrial wastes, or utilize large arc generators to produce ozone which can oxidize the waste dyes. These systems are extremely energy-intensive and are also potentially dangerous due to the high voltages and temperatures associated with these systems. In rural textile plants (such as those which are family owned and operated by native peoples) there is simply no electricity, so all of the waste associated with their textile manufacturing may be dumped into the waterways. Because these dyes are carcinogenic and often acidic in nature, it is easy to predict that the repeated dumping of their waste is going to have adverse effects on the local ecosystem and the health of those in the area.

The theoretical implementation of nanoparticles in a reactor design setting has been studied. Systems such as the PhotoCat by Purifics and other small-scale photocatalytic reactors have been around for a few years. These reactors come in various sizes and configurations with two of the most common being: aqueous-nanoparticle electrical reactors and solar thin-film reactors. Both of these types of reactors are capable of degrading organic particles and utilize photochemically-active nanoparticles to catalyze the degradation reaction.

Aqueous-nanoparticle electrical reactors are roughly based upon three basic components: An input/mixing component, an irradiation chamber, and a filtration component. The input component takes nanoparticles and waste and homogenizes the mixture through sonication to improve the catalytic rate which happens in the next step. The irradiation chamber uses electricity to ionize certain gasses which emit ultraviolet (UV) radiation. This radiation is focused onto the chamber which contains the now homogenized nanoparticle/waste mixture to promote waste oxidation. In the final step, the nanoparticles need to be filtered out of the solution (typically by a ceramic filter) leaving clean water within the reactor. The clean water may then be evacuated from the reactor, and can be recycled or disposed of.

The thin-film reactors require a different setup: the nanoparticles are affixed to a solid surface (typically a corrugated surface to improve surface area) and the waste solution is passed over this monolayer of photocatalytic nanoparticles in order to facilitate the degradation of the organic wastes. This setup allows for regular sunlight or UV lamps to be used to promote the degradation reaction and, with this arrangement, there is no need for filtration because the nanoparticles never actually enter the solution. Binding the nanoparticles to a solid surface drastically decreases the reaction rate because the entire surface area of the nanoparticle is not in contact with the solution.

Although the thin-film reactors can be used and implemented in situations without electricity, those reactors are quite slow due to the fact that the sun's rays are only a very small percent (about 5%) ultraviolet radiation. This implies, for a thin-film reactor, multiple passes are required under normal sunlight to even achieve partial degradation. The aqueous-nanoparticle reactors currently on the market absolutely require an electricity source to at least filter the nanoparticles, and, with each filtration, more and more nanoparticles get trapped in the ceramic filter, forcing more nanoparticles to be input after every few cycles.

### BRIEF DESCRIPTION OF THE DRAWINGS

FIG. 1 is a simplified illustration of one embodiment of a reactor system showing the main components—main reactor, solar concentrator, condenser, and gas bubbler—for performing a vapor-liquid phase separation process for waste treatment and removal;

FIG. 2 is a graph showing a measured solar spectrum on a clear day;

FIG. 3 is a graph and related table showing the optimum nanoparticle concentration using 0.3 g/L initial methylene blue concentration;

FIGS. 4A-4E are images of petri dishes for determining the dependence of pH on the reaction rate of the photodegradation of methylene blue through the excitation of titanium dioxide (anatase) by ultraviolet light;

FIG. 5 is a graph showing the pH for reactor fluid as a function of time after methylene blue is added to the fluid;

FIG. 6 is a graph showing the full spectrum absorbance of the reactor fluid over time;

FIG. 7 is a graph showing the experimental and exponential regression of the methylene blue concentration over time;

FIG. 8 is a graph showing the photocatalytic degradation reaction rate dependence upon the methylene blue concentration for both the exponential fit and finite difference method over the raw data;

FIGS. 9A and 9B are graphs showing gaseous water outflow for different atmospheric temperature isotherms at two different wind speeds; and

FIG. 10 is an illustration showing the proposed reaction mechanism for the production of the highly oxidative hydroxyl radical under anoxic conditions.

FIG. 11 is a graph showing the UV dependence of the oxidation reaction rate.

Corresponding reference characters indicate corresponding elements among the view of the drawings. The headings used in the figures should not be interpreted to limit the scope of the claims.

### DETAILED DESCRIPTION

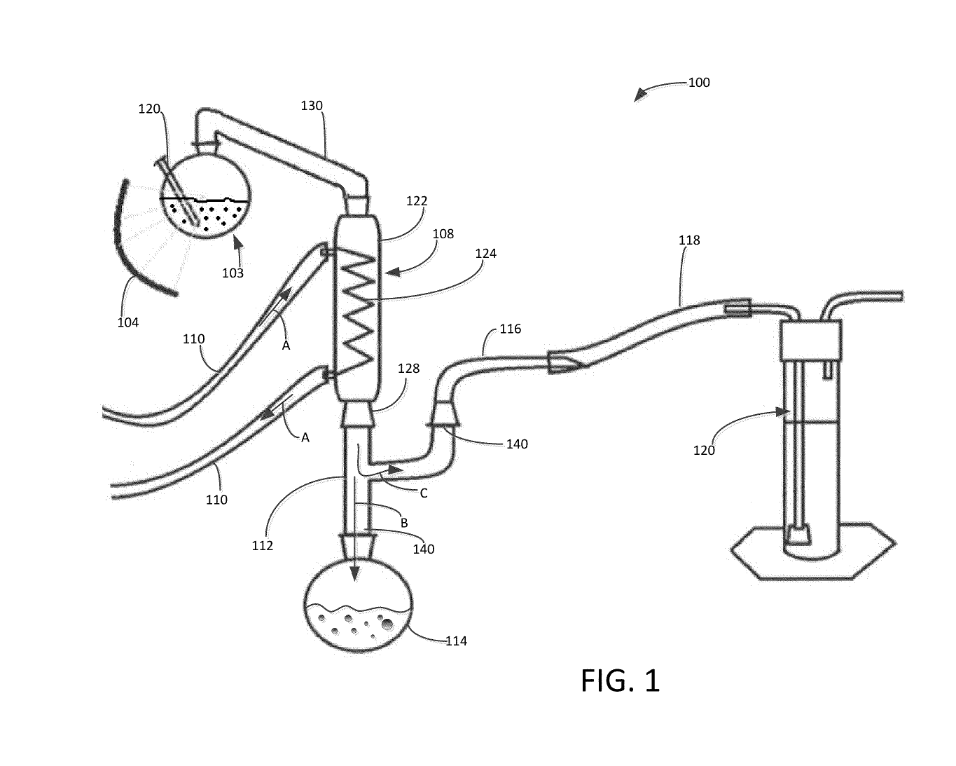

Referring to the drawings, an embodiment for a nanoparticle photocatalytic throughflow reactor system is illustrated and generally indicated as 100 in FIGS. 1-10. In general, the reactor system 100 implements a vapor-liquid phase separation of a fluid in a nanoparticle-type reactor using concentrated solar energy, thereby eliminating the need for filters and surface-bound nanoparticles and achieving isothermal reactor conditions therein to increase photooxidation efficiency.

As shown in FIG. 1, one embodiment of the reactor system 100 may include a main reactor 102 in operative communication with a parabolic solar concentrator 104 which is positioned such that the focus of the parabolic solar concentrator 104 is located just inside the surface of the main reactor 102 providing concentrated ultraviolet radiation to degrade organic pollutants and concentrated infrared and visible radiation to boil off the solvent liquid, such as a polar and protic solvent, disposed within the main reactor 102. The main reactor 102 includes a reactor vessel 103 where all photochemical reactions occur in the liquid contained therein. For example, when the solvent, such as water, is boiled within the reactor vessel 103 (leaving behind the nanoparticles and unoxidized substrate) and a substrate, such as an aqueous organic compound, such as a methylene blue species, in the water is allowed to photooxide to NO, NO₂, CO₂, SO₂ and SO₃. In some embodiments, a port 122 is in communication with the interior area of the reactor vessel 103 for receiving a conventional thermometer (not shown) to take temperature readings and also allow for the addition of reactants and solvent fluid inside the main reactor 102. In addition, the parabolic solar concentrator 104 is oriented such that sunlight is focused onto the center of the reactor vessel 103 that degrades the organic pollutants therein and boils the fluid within the reactor vessel 103 in a measurable ratio 103, thereby allowing a steady-state scenario to be achieved within the main reactor 102 through careful application of control theory.

In one aspect, the main reactor 102 is attached to a condenser adapter 106 that transports water vapor and other gases from the reactor vessel 103 to the condenser 108. For example, in some embodiments the condenser 108 may be a Graham condenser. In one embodiment, the condenser 108 may be a two-glass arrangement having an outer tube 122 that encases a coiled inner tube 124 in which vapor from the reactor vessel 103 flows through the outer tube 122 and cold water flows in direction A through the coiled inner tube 124 via tubes 110 for condensing the vapor from the reaction vessel 103 through a phase separation operation from the outflow stream. It is worth noting that optimum heat transfer efficiency occurs when the cold water in the inner tube 124 flows in a countercurrent direction to the product from the reactor vessel 103 in the outer tube 122. The condenser 108 includes an inlet 126 in fluid flow communication with a conduit 130 that connects the reactor vessel 103 to the condenser 108 at one end and an outlet 128 at the other end of the condenser 108 that communicates with an adaptor 112, such as a Claisen Adapter. In some embodiments, the adapter 112 may be fork-shaped glassware that allows heavier condensate liquid phase to flow in direction B which is, in this arrangement, to be captured within a flask 114 that is attached to a bottom port 140 of the adapter 112, while the gaseous phase continues through a side port 142 in direction C to a gas bubbler 120, such as a bubbler/washer through an angled adapter 116 that connects the side port 142 to tubing 118.

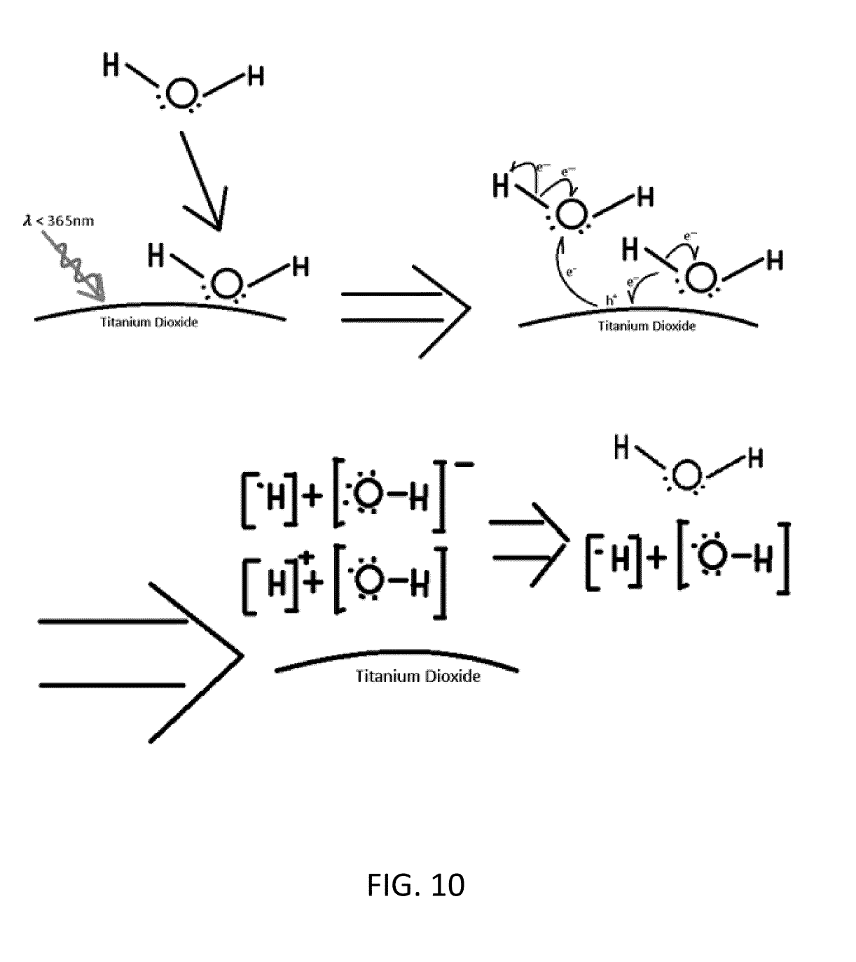

In some embodiments, the gas bubbler 120 may include a packed calcium oxide (CaO) granule bed in which the gaseous phase is flowed through which can result in the reactions shown in FIG. 10. In one aspect, the gas bubbler 120 provides a means for reducing any pollution being discharged to the atmosphere from the main reactor 100. In an alternative embodiment, the gas bubbler 120 may include an aqueous solution in which the gaseous phase is bubbled through rather than a packed CaO granule bed.

The reactor system 100 is also dependent upon a catalytic agent. In particular, the nanoparticles suspended in the nanoparticle fluid within the reactor vessel 103 have a certain catalytic efficiency, and this efficiency varies from nanoparticle to nanoparticle: the physical configuration and crystal structure of the nanoparticle, and the radius of the nanoparticle. For example, a solid, spherical anatase TiO₂ (Titania) with a radius of between 10 nm-15 nm could be used as the nanoparticle. In some embodiments, using different types of nanoparticles of different composition and sizes can achieve higher catalytic efficiency, and therefore a higher throughflow rate being achieved, which would be comparable to operations performed with incinerators and ozone generators currently used in industry.

The reactor system 100 is the very first to implement a vapor-liquid phase separation in a nanoparticle reactor arrangement. By using a phase separation, the reactor system 100 can achieve isothermal reactor conditions for extended periods, much higher reaction temperatures, and a steady-state can be achieved.

In some embodiments, the main reactor 102 may include photochemically-active nanoparticles which are capable of absorbing ultraviolet light and producing, in water, hydroxide radicals. These hydroxide radicals are many times more oxidative than bleach and are the main oxidizing agent in the catalytic degradation reaction occurring in the fluid within the reactor vessel 103. For most organic species, the product of the oxidation reaction is carbon dioxide and water. When the water product mixes with the other solvent, the carbon dioxide leaves as an offgas. A heat source may also be applied, bringing the main reactor 102 to a temperature of approximately 100 Celsius that boils the solvent (water) that leaves as an offgas. The vapor pressure of large organic dye molecules is negligible which implies that the water product that is reclaimed from the condenser 108 is 100% pure, and can be reclaimed and used again in other industrial processes. The nanoparticle separation mechanism for the reactor system 100 is completely effective (100% nanoparticle retention) because the nanoparticles never leave the reactor vessel 103. The 100% nanoparticle retention paves the way for the industrial use of much more expensive nanoparticles that, while offering an increase in photocatalytic activity, are not cost-effective for use in other reactors with lower nanoparticle retention rates.

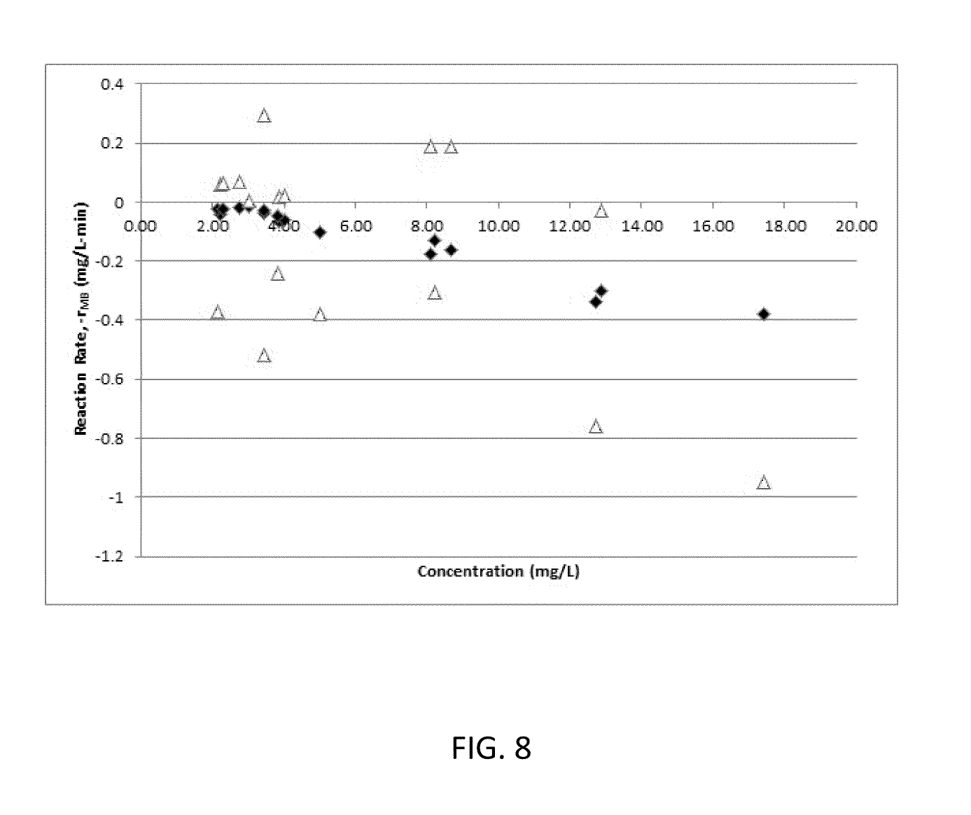

The reactor system 100 has many benefits that are not afforded by batch or semi-batch reactors. Of all of the inherent benefits, the ability to maintain a high reaction rate is paramount. As any reaction proceeds, the amount of reactant decreases and the amount of product increases at relative rates dictated by the stoichiometric coefficients. For this reaction, which occurs in the reactor system 100, as the amount of reactant decreases, the rate of the reaction rapidly decreases as well because there aren't as many reactant molecules for the nanoparticles to contact as shown in FIG. 8. In a steady-state system, where the concentration of reactant is constant, the reaction rate remains constant and high. The efficiency of the reactor system 100, measured in waste degraded per unit time, is higher than other reactors because the reactant concentration is kept constant.

Although the reactor system 100 uses sunlight as both the source of ultraviolet radiation and heat, in some embodiments an analogous system could be built that uses a mercury (Hg) lamp for the source of ultraviolet radiation and a resistive heating element as the heat source.

### Reactor Vessel Configuration

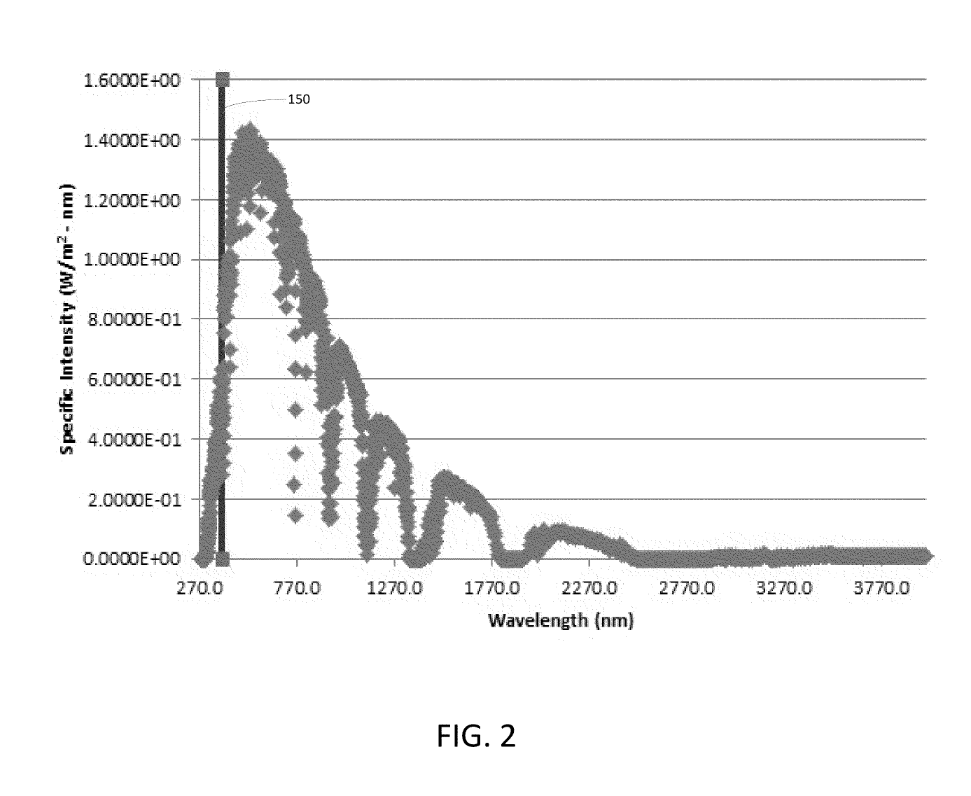

FIG. 2 shows a measured solar spectrum on a clear day with the vertical dividing line, indicated as 150, establishing the boundary between catalytic and thermal spectra. Most nanoparticles have a band gap corresponding to the energy of ultraviolet light photons, though there are some nanoparticles which are capable of utilizing visible light. The ability to utilize more of the solar spectrum can only lead to increased time efficiency as those nanoparticles will incur a greater number of excitations per unit time due to the increased photonic flux in the shifted catalytic spectra. The wavelength of light corresponding to the nanoparticle band gap will be the vertical dividing line 150 between the catalytic spectrum and the thermal spectrum. The amount to which the energy of these two spectra can be utilized by the reactor vessel 103 is a function of the absorbance of the solution as well as the surface reflectivity of the reactor vessel 103. For example, the reflectivity of light off the reactor vessel 103 occurs at the vessel/fluid boundary and vessel/air boundary and should be considered when designing the reactor vessel 103.

In addition, a substantially spherical-shaped reactor vessel 103 positioned at the focus of the parabolic solar concentrator 104, such as a parabolic dish, minimizes the reactor surface reflection by minimizing the incidence angle. Calculations must be done to ensure the focal point is small enough to minimize reflection on a spherical reactor vessel 103. The reactor vessel 103 is placed such that the focus of the parabolic solar concentrator 104 coincides with point just inside of the inner surface of the reactor vessel 103, ensuring boiling of the liquid occurs at a localized point to promote the cavitation-induced mixing of the liquid. This reactor vessel 103 placement introduces significant reflection in an annulus around the focal point. Testing of the parabolic-shaped solar concentrator 104 has shown the focus to be approximately circular with an area of 4 in², resulting in a concentration factor of approximately 1500. The small focal area mitigates the size of the reflection annulus, therefore, the energy loss due to reflections.

FIG. 2 shows experimentally-determined solar spectrum on a clear day that was taken in Phoenix, Ariz. (total transient irradiance: 900 W/m²) in which atmospheric gasses account for all of the deviations from the sun's black body spectral emissions. The vertical dividing line 150 is located at the wavelength (388 nm) corresponding to the band gap of anatase titanium dioxide. The catalytic spectrum is composed of all irradiance at wavelengths less than or equal to that of the band gap, and the thermal spectrum is composed of all irradiance at wavelengths greater than the band gap. Using a Riemann summation, the catalytic spectrum has been calculated, it accounts for only 2.68% of the total spectral irradiance.

### Main Reactor Testing

Primary testing of the reactor system 100 was performed using undoped anatase titanium dioxide (diameter<25nm) with methylene blue as the substrate to be photooxidized. With a band gap energy of 3.2 eV, undoped TiO₂ is by no means the most effective photocatalyst though it is probably the most well-known. A compound with a lower band gap energy has a much larger catalytic spectrum, and a much greater ability to undergo faster catalysis. This is especially true when solar power is the only irradiation source used to power the catalysis; the solar spectrum is composed of only a very small amount of UV light, with visible light making up the majority of the solar spectrum.

The total catalytic spectrum intensity is directly proportional to the size of the parabolic solar concentrator 104 in addition to the transient insolation. The transient insolation (measured by ASU CampusMetabolism) is multiplied by the ratio of the area of the total reflective area of the solar dish over the focal area to give a transient focal point insolation. In one aspect, the glass material made to manufacture the spherically-shaped reactor vessel 103 must be appropriately sized to suit the focal point insolation so excess light energy is not passed through the reactor vessel 103 and there is not non-illuminated space. It is worth noting that a levenspiel plot is trivial for the spherical reactor conditions, as the reactor diameter is bounded, series reactors are not possible due to the vapor-liquid separation, and the reaction rate is fully determined. The reactor vessel 103 has been appropriately sized to theoretically utilize 90% of the normal UV light assuming 28.5 W/m² of ultraviolet light transient insolation, magnified to approximately 22,000 W/m². This translates to a reactor vessel 103 that is 12 cm in inner diameter (not including the borosilicate glass thickness).

One of the advantages to this type of separation mechanism: 100% nanoparticle retention, no residual substrate in the reactor outflow, steady-state conditions can be achieved, and the boiling causes rapid mixing.

The 100% nanoparticle retention is of special importance because it allows nanoparticles made of more expensive materials to be used in industrial applications. The use of ceramic filters or other membranes and surface-immobilized particles discourages the use of nanoparticles made of elements such as platinum because the nanoparticles tend to become lodged in the filter or can break off on the surface, leaving with the outflow. Personal and environmental safety is also an issue when dealing with colloid solutions. Exposure to silver nanoparticles has been shown to cause tissue defects in developing zebrafish (Danio rerio) and several of the nanoparticles used today are labeled as carcinogenic. The full environmental impact of waste nanoparticles is still being studied and the FDA has yet to rule on the acceptable levels of nanoparticles in consumer products, though there is a general consensus that nanoparticles need to be properly handled and treated to minimize environmental exposure. The issue of safety is of particular concern in the consumer goods market, making the reactor system 100 a particularly good choice due to its nanoparticle retention and substrate processing.

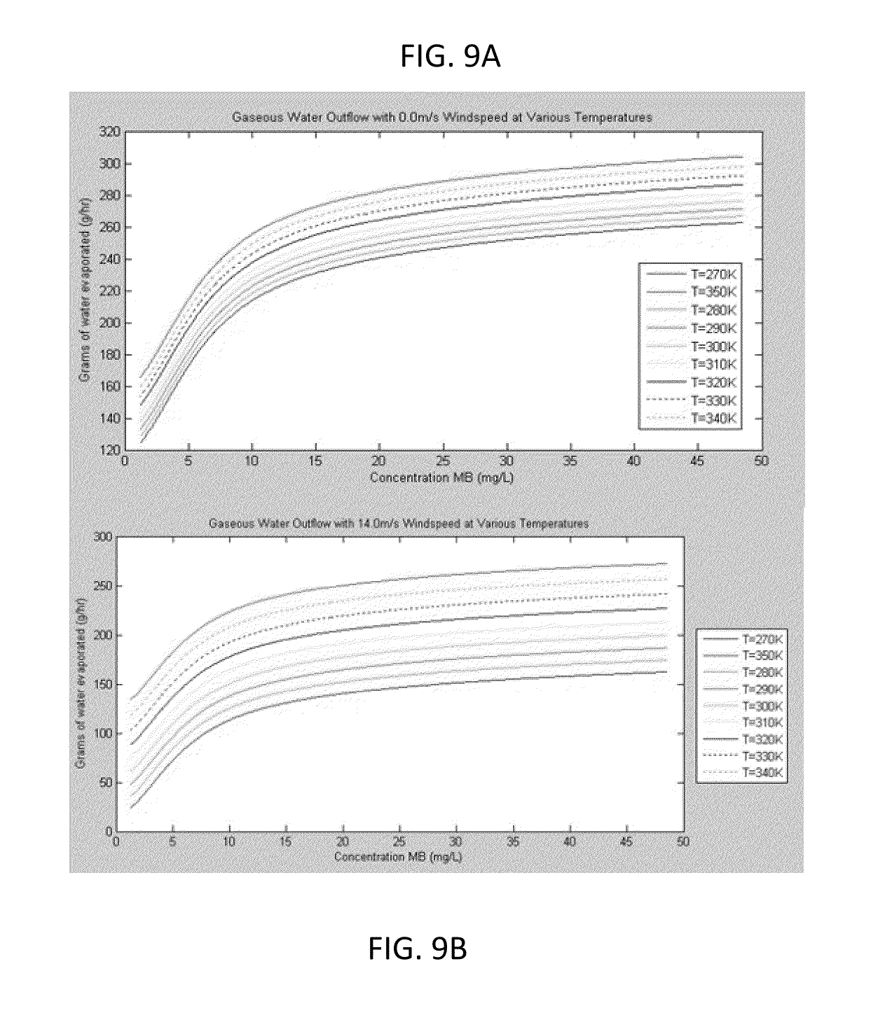

To avoid deviation from steady-state condition, the solvent and substrate must be replaced at a flow rate equal to the solvent vaporization rate and substrate oxidation rate, respectively. The addition of solvent to the reactor vessel 103 needs to be precisely controlled to prevent the boiling of the solution from stopping. The maximum rate of addition of 95° F. solvent (containing the substrate methylene blue) was found to be 2 mL/second or approximately 0.15% of the volume of the reactor vessel 103 every second (minimum reactor residence time of approximately 6 minutes). The solvent boil rate is subject to subtle changes in ambient temperature and wind speed as shown in FIGS. 9A and 9B. Special care must be taken to maintain a constant fluid volume in the reactor vessel 103 to prevent fluid overflow and contamination of the downstream condenser 108 and bulk fluid loss resulting in nanoparticle precipitation.

The substrate concentrations in the input and main reactor 102 also need to be monitored closely to realize steady-state conditions with respect to the substrate mass. The catalytic reaction rate is heavily dependent on the substrate concentration, and by maintaining a high substrate concentration the reaction rate will remain high and steady. The ability to achieve steady-state substrate processing at high concentrations accounts for most of the increased efficiency seen in the reactor system 100. There is an effective limit to this efficiency, as extremely high concentrations push the reaction limiter to the nanoparticle area, and the substrate concentration is no longer the limiting factor. Therefore, for each substrate-nanoparticle pairing there exists some optimum concentration which balances the increasing reaction rate with the effects of high-concentration substrate. This optimum concentration is the subject of complicated mathematical modeling and control engineering.

The concentrated sunlight focused on the rear of the reactor vessel 103 causes film boiling to occur in a very specific location. The rapid fluid vaporization in such a small area combined with the reactor geometry causes the spontaneous formation of a very rapid vortex with an axis running parallel to the ground and perpendicular to the diameter containing the area of film boiling. Mixing is very important not only to eliminate any substrate concentration gradients, but also to prevent nanoparticle aggregation and nanoparticle-wall interactions. Specifically, a small film of nanoparticle precipitate begins to form on the bottom of the reactor vessel 103, forming an opaque surface which scatters the concentrated sunlight; the catalytic reaction stops without sufficient mixing.

This boiling-induced mixing only appears when the heat source has a very large thermal mass and the temperature is very high. Under lower heat conditions, only nucleate and transition boiling occur as these two boiling stages are sufficient to either drain the heat source or diffuse the temperature through the fluid quickly enough to reach a state of thermal equilibrium. The reactor system 100, under ordinary conditions, is unable to achieve this state of boiling. However, by heating the water-nanoparticle solution and then adding the methylene blue, the absorbance of the solution rises instantaneously, and the sudden surge of photo-thermal power is enough to bring the reactor directly into film boiling, essentially skipping over the nucleate and transition boiling stages.

The size of the “shot” of methylene blue needs to be precisely controlled. As previously discussed, if the hot reactor solution is subject to the addition of a relatively large amount of ambient-temperature fluid, the temperature of the main reactor 102 will drop suddenly, and the subsequent boiling will stop at the nucleate stage without developing boiling-induced mixing. Using the mixing described above forces a complex relationship between the mixing angular velocity, the absorbance of the reactor solution, and the transient insolation. While using sunlight, only the first two conditions can be controlled, but the transient insolation is subject to atmospheric effects such as clouds, pollution, and humidity. To achieve long-term steady state condition for several hours, feedback control must be implemented controlling the dissolved substrate flow rate. The full control application and transfer functions will not be given here; the focus of this paper is the physical reactor design.

### Data and Experimental Results

The reactor system 100 underwent tests to determine the optimum efficiency conditions for photodegrading methylene blue. It should be noted that, because the main reactor 102 relies on the absorbance of the reactor's solution, the data expressed here is representative of the substrate methylene blue mixed with anatase titania. If the main reactor 102 were to be used for other purposes with a different pair of nanoparticles and substrates, these experiments would likely need to be redone to properly model different operating fluids and obtain optimum efficiency conditions.

### Optimum Nanoparticle Concentration

The first experiments performed with the reactor system 100 were nanoparticle optimization experiments designed to ascertain the optimum nanoparticle concentration for degrading a standard concentration of methylene blue. These tests were not performed under steady-state conditions, and decolorization time does not imply complete oxidation though the experiments used to detail reaction kinetics data were allowed to come to completion. The experimental results are shown below.

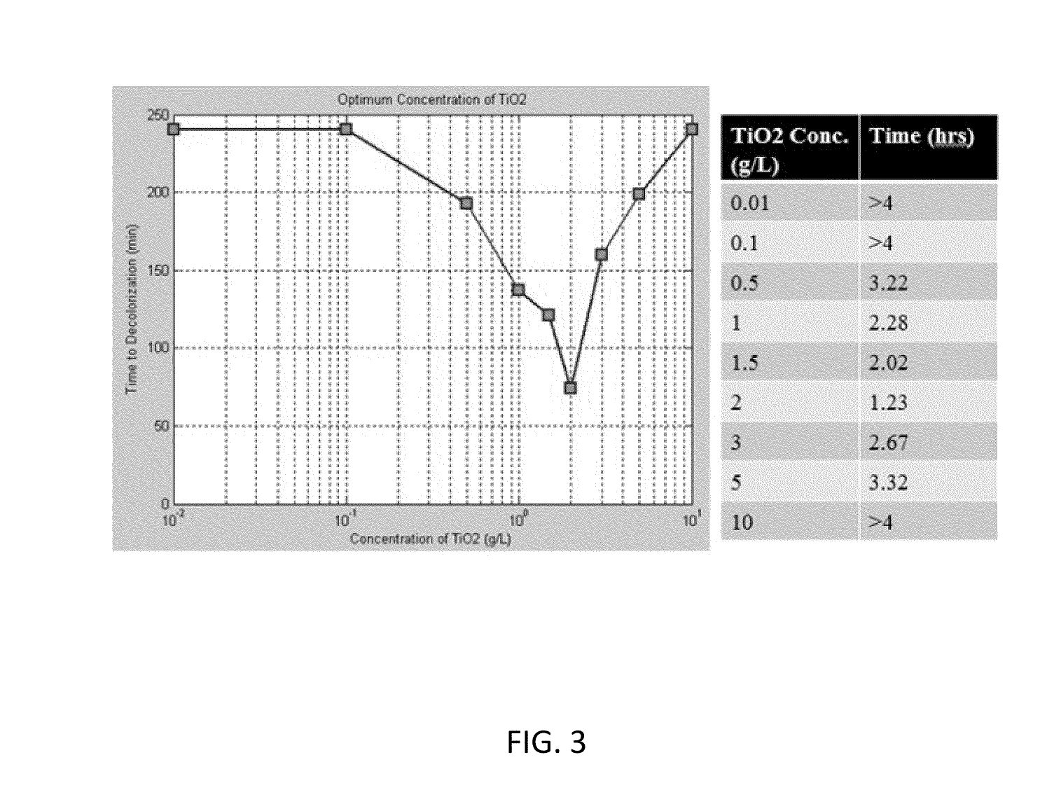

FIG. 3 shows optimum nanoparticle concentration. Each data point an average of three experiments that were conducted. Data obtained using 0.3 g/L methylene blue concentration and the experiments were performed between the hours of 11:00 AM and 3:00 PM GMT/UTC. All data was taken on clear days with unobscured sunshine. Average total solar irradiance: 1100 W/m². Data points at 4-hour mark are representative of experiments which did not decolorize in the 4-hour time window. TiO₂ concentrations measured in dry mass of nanoparticles divided by the volume of solvent (Concentration Relative Error≈±8%)

It was found that the optimum nanoparticle concentration of the solution in the reactor vessel 103 is 2 g/L. Splitting the optimization curve around this minimum, the concentrations that are less than the optimum are limited by the illuminated nanoparticle surface area and the concentrations to the greater than the optimum are limited due to the reactor geometry. Typical colloid solutions are illuminated from above, which makes nanoparticle precipitation a minor issue. The solution, due to the parabolic solar concentrator 104, is illuminated from the bottom, making nanoparticle precipitation a much bigger problem. As the nanoparticle concentration increases, aggregates tend to form much faster and, once a certain mass has been reached, these aggregates tend to fall towards the bottom of the reactor vessel 103 (even with mixing present). With TiO₂ being naturally white, it was found that the aggregates block the concentrated light and inhibit the photocatalytic reaction rate as well as the solvent vaporization rate, and therefore the mixing as well. It is safe to assume that nanoparticles of this density and diameter will always aggregate in the reactor vessel 103 when suspended in a water solvent, though the aggregate size can be minimized through mixing and surfactant use. Therefore, an optimum nanoparticle concentration experiment can be performed with each colloid solution. This optimum value can be used for all subsequent experiments because the interdependence between the colloid surface area and the substrate concentration is overshadowed by nanoparticle aggregation. The optimum concentration of approximately 2 g/L was used in each subsequent experiment and should be the assumed concentration (unless otherwise specified).

### Overall Efficiency

To prove the viability of the reactor system 100, the efficiency of the main reactor 102 over normal solar illumination, several experiments were performed. Table 1 shows the decolorization times for the reactor system 100 and ordinary illumination. For higher accuracy, the tests were performed three different times and on different days. The variance in each data set shows the effects of small humidity changes, windspeed changes and the day-to-day changes in insolation.

TABLE 1
Photooxidation efficiency: methylene blue by titanium dioxide (anatase).

| | | Unconc. Irrad. Time to |
|---|---|---|
| | NPTR Time to Decolorize | Decolor (0.04 g/L MB, |
| | (0.3 g/L MB, 2.0 g/L TiO₂) | 2.0 g/L TiO₂) |
| | (min) | (min) |
| Trial 1 | 74 | 129 |
| Trial 2 | 91 | 120 |
| Trial 3 | 83 | 141 |
| Trial 4 | 105 | 114 |
| Trial 5 | 68 | 139 |
| Average: | 85 | 129 |
| Reaction Rate | 0.3/85 = 0.0035 g/min | 0.04/129 = 0.00031 g/min |
| (g MB/min) | | |

Each row is non-comparative; each of the 10 experiments was performed on separate days. Reactor mixing and temperature were duplicated in the unconcentrated irradiation case. Average solar irradiation (across all ten days): 1050 W/m²; ‘Decolorized’≡absorbance<0.5 at λ=670 nm. Methylene Blue abbreviated to ‘MB’ for simplicity. All data was taken between 11:00 AM and 3:00 PM GMT/UTC in Tempe, Ariz.

It was found that the reactor system 100 is able to decolorize methylene blue over 11 times faster than the unconcentrated solar case. This increase in decolorization rate is mostly due to the concentration of the ultraviolet light, though it is not possible to determine the exact effect the reactor geometry and mixing have on the reaction rates. With these experimental results the reactor system 100 is proven to increase the methylene blue photooxidation rate.

### Optimum pH for Methylene Blue Photooxidation and Acid Buildup

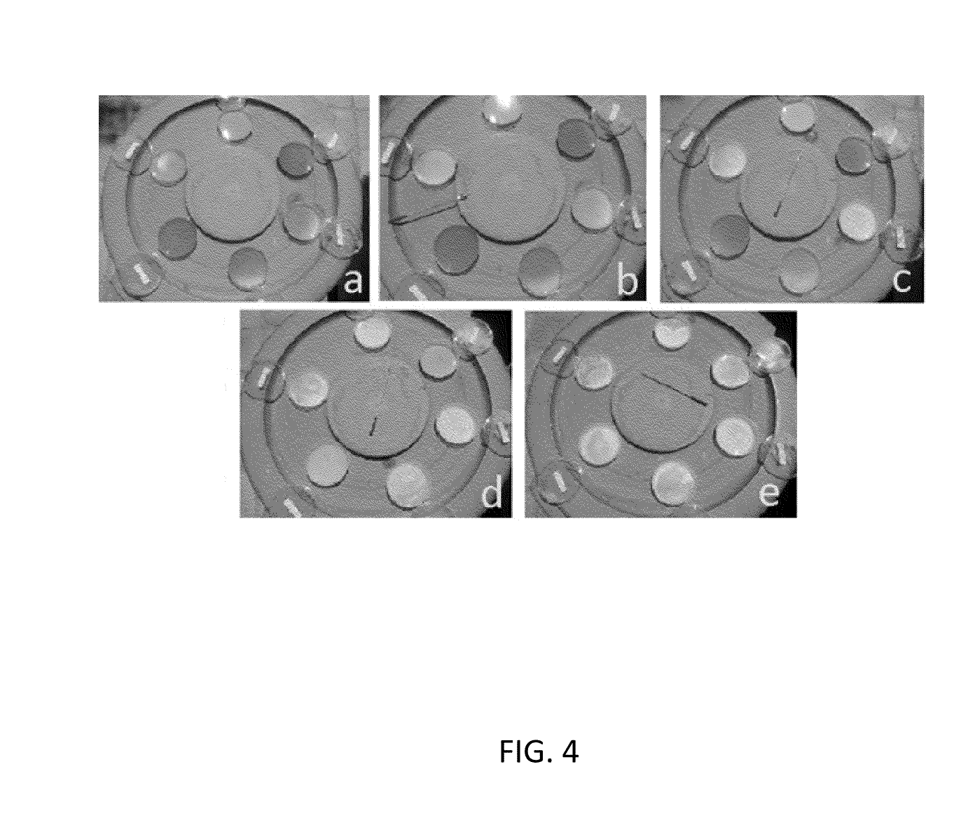

Another of the important process variables that can be tuned to optimize the reactor efficiency is the pH. A pH test experiment was performed and the results are shown in FIG. 4. Upon first adding the titania, the water molecules surrounding the surface of the nanoparticle will dissociate slightly, forming a bond with the surface. Each titanium atom attracts the oxygen atom in water, and the adjacent oxygen atom locked in the titania crystal structure attracts one of the hydrogen atoms from the water molecule (the other hydrogen atom is blocked from the surface by water's molecular geometry), creating a TiOH transient surface structure. When the pH is lowered, the increase in H⁺ ions immediately changes the surface into a hydronium-like compound TiOH₂⁺ which repels the methylene blue, hindering methylene blue absorbance. In a basic solution, the hydroxide ions tend to steal the hydrogen from an adsorbed water molecule, generating TiO⁻ from the surface TiOH. This negatively charges the surface, and the attraction between the methylene blue and the surface increases adsorbance, giving a more rapid degradation reaction. This is proved in FIG. 4, which shows the petri dishes with a higher pH reacted fastest, resulting in a clear solution of the nanoparticles. The experiment also shows that extremely acidic solutions (pH 2) also finish more quickly than the pH range closer to neutral. The effectiveness of lower pH ranges may be attributed to an increased efficiency in later reactions (the oxidation reactions which occur after the first hydroxyl radical attacks the positively charged group on methylene blue). Also, the acid ions may help to stabilize the hydroxyl radicals generated on the surface of the titanium dioxide.

FIG. 4 shows experimental test to determine the dependence of pH on the reaction rate of the photodegradation of methylene blue through the excitation of titanium dioxide (anatase) by ultraviolet light. The order of petri dishes in each picture is (starting at the 12:00 position and moving clockwise): pH 11, pH 9, pH 2, pH 7, pH 4, and pH 13. The time between photos is 15 minutes, with (a) being after 15 minutes of direct solar exposure, with the final petri dishes (pH 9, 7, and 4) taking 75 minutes to BE completeD. Petri dishes were stirred vigorously every 5 minutes. Evaporation is accounted for before data is taken by re-diluting with DI water.

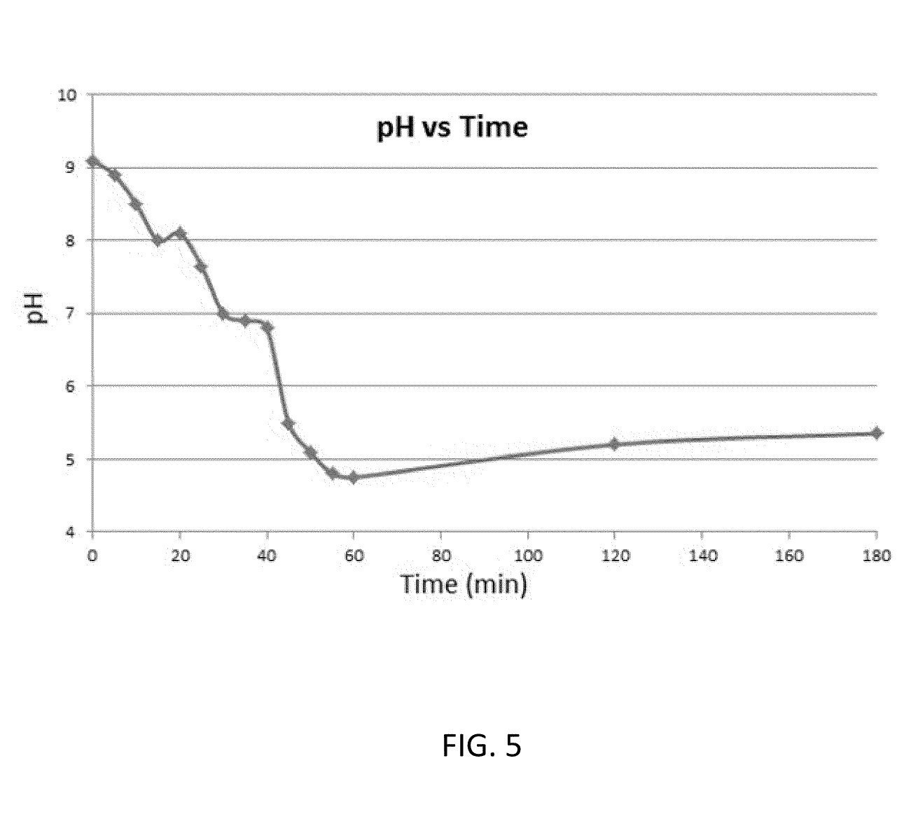

The pH in the reactor system 100 begins close to nine (before the addition of methylene blue) but the pH changes as the reaction proceeds. The production of hydroxyl radicals on the surface of titanium dioxide causes the oxidation of the two nitrogen and one sulfur atoms present in every molecule of methylene blue into their most oxidized form: as nitric and sulfuric acids. These acids build up in the system over time, dropping the pH rapidly as shown in FIG. 5. This pH buildup makes steady-state conditions much more difficult to achieve. It may be possible to partially reduce these compounds into their dioxide forms but the reductant would be continually wiped out by the hydroxyl radicals causing an overall loss in efficiency.

FIG. 5 shows reactor fluid pH as a function of time after the methylene blue is added. Methylene blue added at time zero, and the reactor core was removed from the parabolic solar concentrator 104 and placed in the dark at 60 minutes. The experiment began at 12:00 PM GMT/UTC,with average insolation during the irradiation phase of the experiment was approximately 1025 W/m².

The reaction above proceeded to near complete decolorization at the 60-minute mark. The range of pH values implies that photooxidation of nitrogenous or sulfurous compounds using anatase titania is not possible without acid buildup under normal conditions. More interesting is the increase in pH after the solution was kept in the dark. The increase in pH came along with a color change, implying that the decolorization reaction is partially reversible when methylene blue becomes leukomethylene blue through the reduction of the central nitrogen group and the interruption of the resonance structure. Using the pH guide above, the amount of reversibly decolorized methylene blue can be quantified by the pH change after the reactor is removed from the light source.

The hydronium ion concentration in the reactor vessel 103 increases with the amount of methylene blue that is photodegraded, with a constantly decreasing pH implying very unsteady-state conditions. Future research will be focused on fitting and benchmarking the reactor to utilize titanium dioxide (P90 or P25) for the photoreduction of carbon dioxide. This approach circumvents the acid buildup problem by never introducing acid precursors (electronegative elements) into the reactor. There is also research being done applying electroreduction to nitrates and sulfates to reduce them to oxides and water. How electroreduction would interfere with photochemical nanoparticle-catalyzed reactions has yet to be studied.

### Steady-State Reaction Kinetics

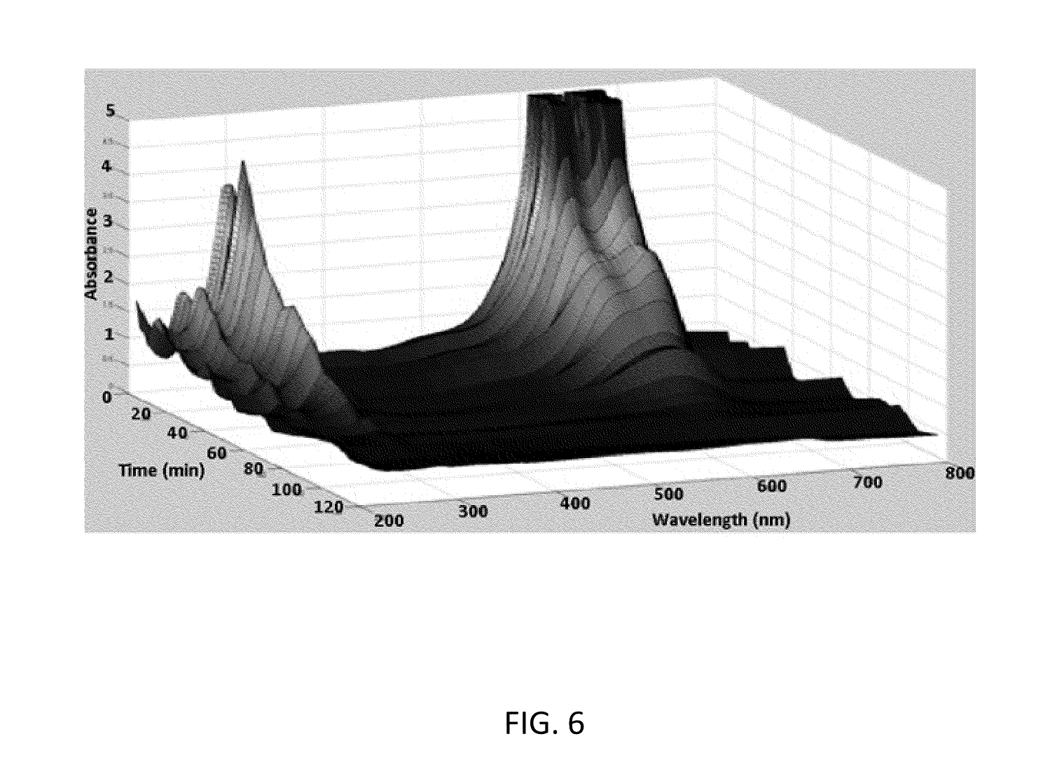

To better visualize the effect of steady-state condition in the reactor system 100, the reaction kinetics with respect to methylene blue need to be better understood. Using a spectrophotometer the visual spectrum absorbance of the reactor fluid was tested at regular intervals as the reaction proceeded. The full-spectrum absorbance over time is given in FIG. 6.

FIG. 6 shows a solution of 2 g/L titanium dioxide (anatase, diameter<25 nm) and 0.042 g/L methylene blue irradiated with unconcentrated sunlight for 2 hours. Samples were taken at regular intervals, and processed using a Shimadzu 2401 UV/Vis Spectrophotometer to determine the absorbance for near UV, visible, and short IR wavelengths. Most of the nanoparticles precipitated out; the solution was decanted and then filtered to minimize the light scattering. Samples were left undiluted to maintain experimental dimer (MB⁺)₂ and trimer (MB⁺)₃ concentrations.

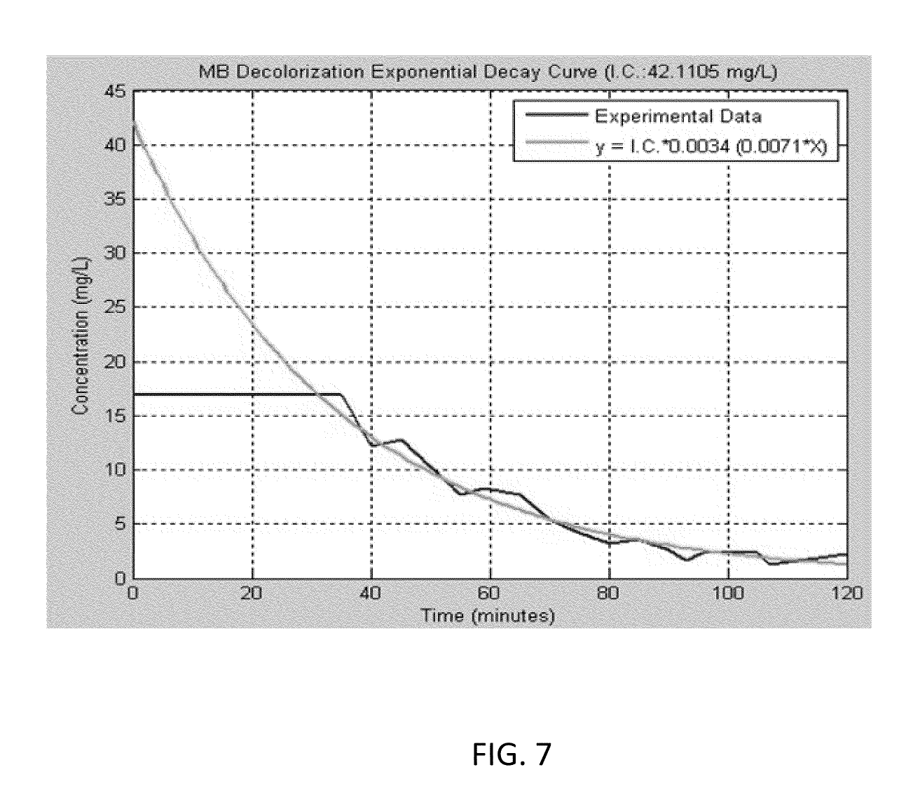

Using the tabulated molar extinction coefficient for cationic, monomolecular methylene blue (MB⁺) at 664 nm, an estimation of the methylene blue concentration over time was calculated using the Beer-Lambert Law (shown in FIG. 7). Neglecting the saturated measurements, an exponential regression has been drawn over the remaining points. An exponential regression was chosen because the overall behavior (beginning at a certain concentration at time zero and a concentration of zero at infinite elapsed time) matches the chemical characteristics present for the oxidation reactions. From the regression, tabulated reaction rates at every discreet time for which there is a concentration measurement. This data can be used to determine the rate law with respect to the methylene blue concentration, c_{MB}.

FIG. 7 shows the experimental (blue) and exponential regression (green) of the methylene blue concentration over time. Regression was drawn over all unsaturated measurements generated using the Beer-Lambert law. Samples were taken at regular intervals, and processed using a Shimadzu 2401 UV/Vis Spectrophotometer to determine the absorbance for near UV, visible, and short IR wavelengths. Test performed between 11:00 AM and 1:00 PM GMT/UTC with an average total solar irradiance of 1020 W/m².

The nature of the surface catalysis makes the rate law quite complicated because not only do the nanoparticle and substrate concentrations determine the reaction rate, but the light intensity, nanoparticle diameter, and substrate absorbance as well. It would be wrong to simplify the list to the nanoparticle concentration and the illuminated titanium dioxide surface area due to the extra spatial dimension involved in an aqueous reactor. The average inter-nanoparticle distance is a rate-limiting factor as well, and it is inherent in the nanoparticle size and concentration. A proposed pseudo ‘α’-th order rate law giving the rate of disappearance of methylene blue is shown below:

r_{MB}=Z(c_{MB})^{α}

The thermodynamic rate law is present in these three terms, with a substitution of ‘Z’ for the usual ‘k’ to avoid confusion between the two. The ‘Z’ coefficient incorporates not only the thermodynamic terms, but the nanoparticle size, nanoparticle concentration, transient insolation, and illuminated surface area as well, hence the term ‘pseudo-order’. The exponential constant, α, can be determined from the concentration vs. time data, reorganized in FIG. 7 below.

FIG. 8 shows the photocatalytic degradation reaction rate dependence upon the methylene blue concentration. Reaction rate estimated using an exponential fit (filled diamonds) and using finite difference method with non-homogeneous spacing (empty triangles). Data clustering is due to irregular sampling times and reaction pathway; high variance in the finite-difference approach is expected.

Though the finite-difference method covers a very wide range due to variance in the experimental data, there is a clear first-order relationship between the methylene blue concentration and the decolorization reaction rate. A linear regression can be drawn over the points with the form of: y=mx. If the substrate concentration is zero, the reaction rate cannot proceed (r_{MB}=0) which accounts for the lack of a y-intercept. The rate constant, ‘Z’, is estimated to be the slope of the linear regression, defining the experimental rate equation:

−r_{MB}=0.0211*(c_{MB})² From the exponential fit data set

−r_{MB}=0.0300*(c_{MB})² From the finite difference data set

Having proved that the reaction rate is not zeroth-order with respect to the substrate concentration, the benefits of a steady-state reactor can be explored. Maintaining a high substrate concentration by manipulating the inlet volumetric flow rate and inlet concentration leads to more substrate reactions per unit time. The ratio of the substrate processed by unsteady-state versus that processed by steady state (named the efficiency amplifier) is defined as the ratio of the integrals of the reaction rates with respect to time:

$$\frac{- {r}_{MB , Steady}}{- {r}_{MB , Unsteady}} = \frac{{\int }_{0}^{{t}_{f}} {Zc}_{MB , 0} d t}{{\int }_{0}^{{t}_{f}} {Zc}_{MB} d t}$$

Using the experimentally-determined equation for the unsteady-state methylene blue concentration:

$$\frac{{\int }_{0}^{{t}_{f}} {Zc}_{MB , 0} d t}{{\int }_{0}^{{t}_{f}} Z * {c}_{MB , 0} * {0.0034}^{0.0072 t} d t} = \frac{{Zc}_{MB , 0} {t}_{f}}{{Zc}_{MB , 0} * ( 24.7793 - 24.7793 {e}^{- 0.040256 {t}_{f}} )} - \frac{{t}_{f}}{24.7793 ( 1 - {e}^{- 0.040256 {t}_{f}} )}$$

The above equation provides a mathematical solution to the efficiency amplifier. For all non-negative ending times, t_{f}, strictly greater than zero, the efficiency is greater than one, implying steady-state conditions will always improve the amount of substrate processed. The reactor system 100 is capable of efficient waste processing while maintaining 100% nanoparticle retention due to its vapor-phase separation mechanism, while competing nanoparticle reactors which rely on membranes and/or filters to perform the nanoparticle-fluid separation, there will always be trace amounts of the substrate present. The amount of substrate which remains is determined by the reactor itself and the residence time of each infinitesimal solution volume.

### Oxygenated Redox Reaction Kinetics:

The oxidation of organic wastes requires the in situ formation of hydroxyl radicals, typically from hydrogen peroxide. On the surface of TiO₂, hydrogen peroxide can be generated from molecular oxygen and water via the following redox reactions^{[1]} (where h⁺ represents a positively-charged hole on the TiO₂ surface, and e⁻ represents a negatively-charged electron in the conducting band of TiO₂):

| | |
|---|---|
| TiO₂ + hv → e⁻ + h⁺ | (e⁻ + h⁺ → ΔH) |
| O₂ + e⁻ → O₂°⁻ | (O₂⁻ + h⁺ → ΔH + O₂) |
| A. O₂°⁻ + H⁺ → HO₂°\| | |
| B. H⁺ + e⁻ → H° | (H° + H° → H₂) |
| O₂ + H° → HO₂° | |
| 1. 2HO₂° → H₂O₂ + O₂ | (2H₂O₂ → 2H₂O + O₂) |
| 2. H₂O ⇄ H⁺ + OH⁻ + h⁺ → H⁺ + OH° | (H° + OH° → H₂O) |
| H⁺ + e⁻ → H° | (H° + H° → H₂) |
| HO₂° + H° → H₂O₂ | (2H₂O₂ → 2H₂O + O₂) |
| 3. 2OH° → H₂O₂ | (2H₂O₂ → 2H₂O + O₂) |
| H₂O₂ + e⁻ → OH⁻ + OH° | (OH° + H° → H₂O \| |
| | H⁺ + OH⁻ → H₂O) |

Each reaction used in the generation of hydroxyl radicals is shown on the left, and each reaction which can competitively eliminate hydroxyl radicals or the reaction intermediates is shown on the right.

Before further discussion it is worth noting that none of the above reactions (except the first two) are easily reversible, as the spontaneous formation of radicals is thermodynamically unfavorable; the forward reactions and those radicals are formed due to the light energy input in the first step. It can also be shown that a minimum of two excitations are required to produce H₂O₂ from light; however, the final oxidant, OH°, can be generated by only one excitation through the mechanism shown in 2. It has been demonstrated that the anoxic oxidation of methylene blue on nanoscale titania is quite slow compared to the oxygenated versions, implying the first steps in mechanism 2 are not the dominant mechanisms in the formation of hydroxyl radicals. Likewise, mechanism 3 is a competitive form of the formation of hydrogen peroxide; the two hydroxyl radicals are more reactive than the hydrogen peroxide and the subsequent reaction with titania will only produce a single hydroxyl radical.

The presence of a fenton-type catalyst or other disproportionation catalysts which increase the hydroxyl radical concentration, mechanism 3 could pose a significant sink for the reactor's photocatalytic efficiency. For clarity, an example of a fenton's reagent addition to the reactor is shown below:

Fe²⁺+H₂O₂+H⁺→Fe³⁺+HO°+H₂O

Fe³⁺+H₂O₂→Fe²⁺+HO₂°+H⁺

The overall photo-fenton catalysis mechanism would be more energy-efficient due to not needing the third light excitation to generate the hydroxyl radicals from hydrogen peroxide, but it comes at the cost of using hydrogen peroxide to regenerate the ferrous ion and the hydrogen peroxide precursor, HO₂°.

The ionized oxygen molecule requires the addition of a hydrogen atom in both schemes (A and B) which accounts for the increase in oxidation rates under low pH conditions. Although the adsorption of methylene blue onto the nanoparticle surface goes down considerably because the titania becomes positively-charged through the competitive adsorption of H⁺ ions. The adsorption of the methylene blue is not totally required in the photo-fenton case because the formation of hydroxyl radicals can occur without the excitation from the TiO₂ surface, although the coordination of the ferrous ion and the cationic methylene blue is still magnetically unfavorable.

The valence band holes that are generated on the surface of TiO₂ are used to generate hydroxyl radicals directly as shown in mechanism 2, or they can be used to directly reduce the substrate. The direct reduction is not proposed to occur in the first step due to the positive charge of the dye. After the ring dissociation, however, this reducing power is very useful for cleaving the resulting hydrocarbon bonds. Specifically, the production of ammonium is possibly due to the reduction of the methylamine groups on the dye molecule.

Recent research has shown that the first reaction in the decolorization of methylene blue is a central ring-opening reaction due to the oxidation of the sulfur atom and the required resonance stability. The subsequent oxidation of the sulfur atom generates a sulfoxide and another dimethyl-aniline group. It is difficult to ascertain a specific rate law for each catalytic step of the reaction because the first steps lead to two cyclic products which also interact with the nanoparticle surface and hydroxyl radicals. As well, the oxidation of the sulfoxide and ammonium groups to sulfuric and nitric acids lower the pH considerably over the course of the experiment.

More experimentation will need to be performed to determine an empirical expression for ‘Z’ in the proposed rate law however, the transient irradiation term incorporated in the constant, ‘Z’, can be further split into the catalytic spectrum and the visible/heat spectra.

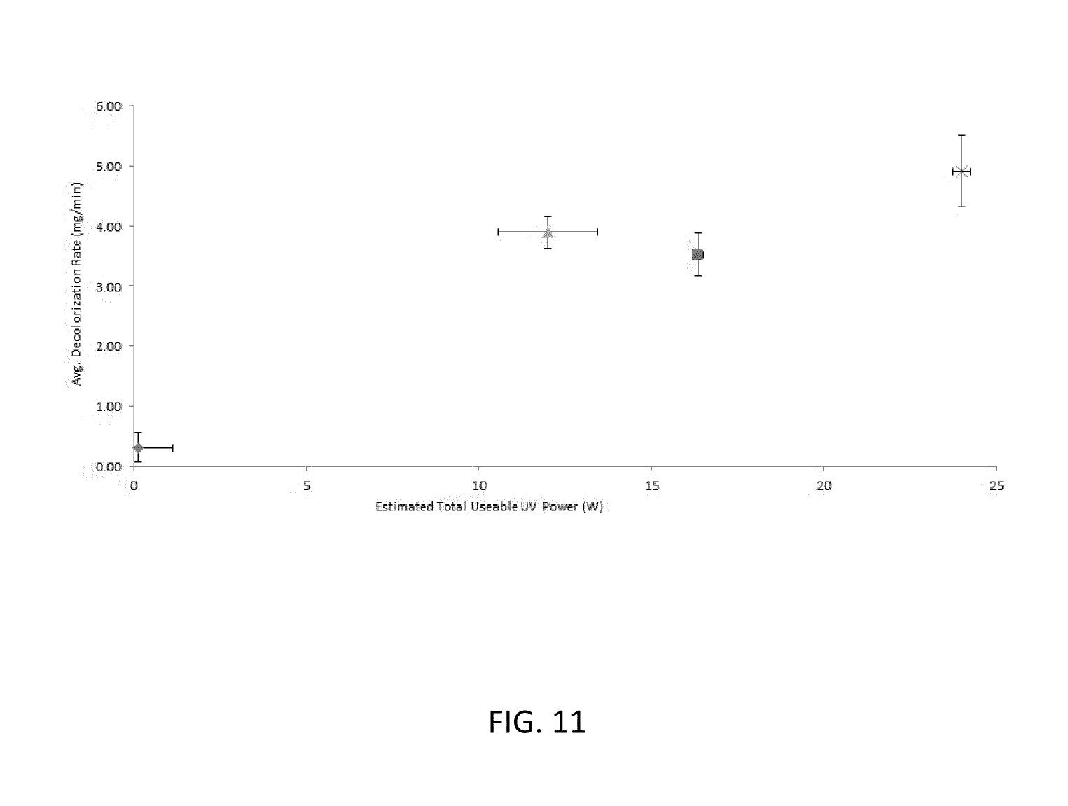

FIG. 11 displays the ultraviolet dependence of the reaction rate. The correlation appears to be linear over the range tested, but further testing is required to determine the dependence of reaction rate at very high UV concentrations. It is unexpected that a UV concentrator 104 would be much bigger than the one used here, so a roughly linear relationship can be established. Over this interval, the kinetics equation Z-term can be rewritten in terms of the ultraviolet power ([UV]) and a new constant term (Z′):

Z=Z′[UV]

The temperature in the reactor can be iteratively defined from the heat spectrum irradiance from the Beer-Lambert law and an overall energy balance:

$$Energy Accumulation = Energy in - Energy out$$

$$\frac{d T}{d t} = ( Power in - Power out ) * {c}_{p}$$

Where ‘cₚ’ is the constant-pressure heat capacity and the power input can be calculated from the wavelength-specific fractional transmittance (T_{λ}), the photon path length through the reactor (I, measured relative to the spectrophotometer photon path length), and the wavelength-specific spectral irradiance (I_{λ}) of the light source over all wavelengths greater than the corresponding band-gap (λ=388 nm); shown explicitly in the following equation:

$$Power In = {\sum }_{λ = 399}^{∞} ( 1 - {( {T}_{λ} )}^{1} ) {I}_{2}$$

This equation is only valid when the assumption is made that the heat spectrum is the only source of energy into the reactor, a valid assumption when considering the catalytic spectrum is very small by comparison and the total enthalpy of reaction is small for lower respective concentrations. The reactor system 100 is powered entirely by the sun which strongly emits light between 200 nm and 2500 nm limiting the infinite sum to a finite length. The power output can also be calculated as a flux out of the reactor due to radiation, conduction and convection to the surroundings through the reactor walls and the heat energy lost due to the vaporization of the solvent. The energy flux through the walls is dependent upon atmospheric conditions such as humidity, barometric pressure, wind speed, and ambient temperature.

FIGS. 9A and 9B show gaseous water outflows for different atmospheric temperature isotherms and at two different wind speeds are illustrated. FIG. 9A: wind speed=0.0 m/s; FIG. 9B: wind speed=14.0 m/s. Calculations performed assuming dry air at 1 atm barometric pressure. Transient insolation=1000 W/m². All calculations performed in MatLab R2012a programing environment.

Under steady-state conditions, the temperature remains constant in the reactor vessel 103 and the changes in the transient insolation and atmospheric conditions result in a different amount of solvent vaporization. One of the few control variables is the inlet flow rate, which must be precisely controlled to prevent overflow or excessive dimerization at very low or high methylene blue concentrations respectively. A mathematical model was developed to predict the water evaporation rate at different ambient temperatures and wind speeds including natural convection preliminary predictions are shown.

The absorbance of methylene blue plays an equally important role in determining the evaporation rate over all ambient temperatures and wind speeds, indicated by the similar curvature and shape of each of the isotherms on each sub-graph. This behavior is expected because the solution absorbance is essentially the only source of heat energy. Deviation from plot to plot would indicate auxiliary effects and another possible heat source. Another interesting phenomenon is the leveling-off of every curve above a methylene blue concentration of 10 mg/L which persists over all ambient temperatures and wind speeds. Due to this “critical concentration,” the reactor system 100 should only be operated at concentrations above 10 mg/L to avoid sudden changes in the solvent vaporization and subsequent overflow due to inherent lag in computer control.

Photoreduction and Fuel Production from Atmospheric Gasses

Photoreducing carbon dioxide with the use of photocatalysts has been studied, and is gaining popularity due to sustainability and wide availability of these common resources. By photoreducing carbon dioxide with only solar power and photocatalysts, electrical and chemical energy does not have to be used to generate fuel. Nanoscale photocatalysts are a prime candidate for the photoreduction of CO₂ because of their high surface area, reuseability, and high photochemical activity. The inventors have discovered that the reactor system 100 is an excellent candidate for photoreducing carbon dioxide.

If a steady-state condition can be established using the reactor system 100 the photocatalysts used to help reduce carbon dioxide will not have to be dumped out for every run. This will cut down on the cost of the materials used to run this system. The reactor system 100 has also shown that it is possible to generate a mixing motion within the reactor vessel 103 without the use of rotators or stirrers. This makes the reactor system 100 even more appealing because solar power can be used help mix the photocatalyst and carbon dioxide or any other material.

To ensure the widespread availability and cost-effectiveness of the reactor system 100, a nanoparticle must be chosen which is widely available, well-known, and well-suited to reactor conditions. Such properties that might make a photocatalytic nanoparticle well-suited to reactor conditions is resistance to corrosion and photocatalytic activity. One particular nanoparticle mixture that fits these conditions is a titanium dioxide mixture that is referred to as P25-type TiO₂. This mixture of titanium dioxide contains both anatase and rutile phases of this molecule¹, giving it unique chemical properties. This particular nanoparticle is popular in research that focuses on carbon dioxide reduction using solar power because it is relatively cheap compared to other nanoparticles used, and is resistant to corrosion. Corrosion resistance is beneficial in any photocatlytic application because the catalyst would have a longer lifespan inside the reactor vessel 103, which will cut down on the cost of the materials.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A reactor system comprising:
a main reactor including a reactor vessel configured to receive a solution, the solution comprising a concentration of nanoparticles suspended in a solvent;
a source of ultraviolet radiation for generating heat within the reactor vessel for causing one or more photochemical reactions in the solution under a steady-state condition within the reactor vessel and producing a vapor from the solvent that allows the concentration of nanoparticles to remain within the reaction vessel as the solvent is converted to vapor; and
a condenser in fluid flow communication with the reaction vessel for causing a phase separation of the vapor into a heavier condensate liquid phase and a lighter gaseous phase.

2. The reactor system of claim 1, wherein the condenser includes a first pathway for transport of the vapor and a second pathway surrounding the first pathway for flow of a liquid maintained at a colder temperature relative to the vapor for causing the phase separation of the vapor into the heavier condensate liquid phase and the lighter gaseous phase.

3. The reactor system of claim 2, wherein the first pathway is in fluid flow communication with a third pathway for transport of the heavier condensate liquid phase and a fourth pathway for the transport of the lighter gaseous phase.

4. The reactor system of claim 3, wherein a storage chamber is in fluid flow communication with the third pathway for collecting the heavier condensate liquid phase from the condenser.

5. The reactor system of claim 3, wherein a gas scrubber is in fluid flow communication with the fourth pathway for filtering of the lighter gaseous phase transported from the condenser.

6. The reactor system of claim 5, wherein the gas scrubber includes a second liquid for filtering the lighter gaseous phase.

7. The reactor system of claim 5, wherein the gas scrubber comprises a packed granule arrangement for filtering the lighter gaseous phase.

8. The reactor system of claim 7, wherein the packed granule arrangement is a ceramic granule bed comprising a calcium oxide material.

9. The reactor system of claim 2, wherein the reactor vessel defines a substantially spherical-shaped configuration.

10. The reactor system of claim 1, wherein the concentration of nanoparticles in the solution is about 2 g/L.

11. The reactor system of claim 1, the solution comprising a substrate.

12. The reactor system of claim 11, wherein the substrate comprises an aqueous organic compound.

13. The reactor system of claim 1, wherein the solvent comprises a polar and protic solvent.

14. The reactor system of claim 1, wherein the heat generated within the reactor vessel is sufficient to maintain the solvent at a boiling point.

15. A method for removing an aqueous organic compound from a solution comprising:
disposing a solution inside a reactor vessel, the solution comprising:
a solvent;
a concentration of nanoparticles suspended in the solvent; and
a substrate mixed with the solvent;
applying solar energy onto the reactor vessel for generating heat within the reactor vessel and producing a steady-state condition within the reactor vessel;
boiling the solution to cause a phase separation for generating a vapor from the solution;
causing a chemical reaction in the solution; and
condensing the vapor into a heavier condensate liquid phase and lighter gaseous phase outside of the reactor vessel;
wherein the concentration of nanoparticles remains in the reactor vessel as the solvent is converted into vapor.

16. The method of claim 15, wherein the concentration of nanoparticles is about 2 g/L.

17. The method of claim 15, further comprising:
filtering the lighter gaseous phase and collecting the heavier liquid phase.

18. The method of claim 15, wherein the substrate comprises an aqueous organic compound.

19. The method of claim 15, wherein the chemical reaction in the solution is a photooxidation of the substrate.

20. The method of claim 15, wherein the chemical reaction in the solution is a heterogeneous catalytic reaction.
